(19) United States
(12) Patent Application Publication
(10) Pub. No.: US 2008/0205075 A1
(43) Pub. Date: Aug. 28, 2008

(54) Light Module For Producing Light With a Scattering Pattern That is Electrically Variable and Use Thereof as a Multiple Purpose Light

(75) Inventors: Rifat Ata Mustafa Hikmet, Eindhoven (NL); Ties Van Bommel, Eindhoven (NL); Albrecht Kraus, Kerkrade (NL); Walter August Schlager, Bocholtz (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,555

(22) PCT Filed: Jul. 4, 2006
(86) PCT No.: PCT/IB2006/052249

§ 371 Date: Jan. 3, 2008

(30) Foreign Application Priority Data
Jul. 8, 2005 (EP) 05106246.1
Sep. 9, 2005 (EP) 05108295.6
Jan. 20, 2006 (EP) 06100661.5

(51) Int. Cl. B60Q 1/00

(52) U.S. Cl. 362/488

(57) ABSTRACT

The invention provides a light module (1) with a light source (2) for emitting a beam of light (5), an adjustable optical element (300) for adjusting the beam of light (5) from the light source (2) into an adjusted beam of light (25) with a scattering pattern that is electrically variable; and a controller (304) for controlling, in response to an adjusting control signal (371), at least one element of a group of elements comprising the adjustable optical element (300) and the light source (2) by means of at least one driving signal (375, 376). A multi-purpose light, for example for interior car lighting, is advantageously provided thereby.

### FIELD OF THE INVENTION

The invention relates to a light module, to a controller for use in the light module, and to a computer program product.

### BACKGROUND OF THE INVENTION

A large number of light sources are used for performing various interior lighting functions in present day cars. Spots are used as reading lights and somewhat more diffuse lighting may be used for vanity and comfort lighting. There are also lamps placed by the car door(s) to illuminate the stepping area into the car. Various light sources are thus used within cars for various functions such as reading light, vanity light, stepping light, etc.

An example of an interior car light is described in EP0669224. This document describes a courtesy lamp housing inside a car having two separate chambers with bulbs, one for map reading and one for general illumination. The lens of the reading lamp and its bulb, plus the wall dividing the two lamp chambers and the two contacts, together form a single unit which fits inside the first lamp chamber and which can be removed for bulb replacement. Here, two lights are used for different purposes.

### SUMMARY OF THE INVENTION

Prior art interior car lights usually produce a light beam of which the shape or properties cannot be adapted and cannot be used for multiple purposes.

Hence, it is an aspect of the invention to provide a light module for producing light with electrically variable scattering properties. It is a further aspect of the invention to provide a multiple purpose light, especially for use in interior car lighting.

It is also one of the aspects of the invention to provide a light module which can be relatively user friendly.

Further aspects of the invention are to provide a controller for use in a light module and a computer program product which can be relatively user friendly and/or which provide the multi-purpose effect.

The invention provides a light module for illuminating an object comprising:

a light source for emitting a beam of light,

an adjustable optical element being arranged to adjust the beam of light originating from the light source into an adjusted beam of light with a scattering pattern that is electrically variable, and

a controller being arranged to control, in response to an adjusting control signal, at least one element of a group of elements comprising the adjustable optical element and the light source by means of at least one driving signal.

According to a next aspect of the invention, a controller is provided for use in or with the light module, the controller being arranged to control, in response to an adjusting control signal, at least one element of a group of elements comprising the electrically adjustable optical element and the light source by means of at least one driving signal. The controller may control more than one light module.

According to yet another aspect of the invention, there is provided a computer program product to be run on a controller, the computer program product comprising the function of controlling, in response to an adjusting control signal, at least one element of a group of elements comprising the electrically adjustable optical element and the light source by means of at least one driving signal.

More in particular, a light module is provided which produces more than one beam of light, said light module comprising:

a. more than one source arranged to provide more than one beam of light; and
b. more than one electrically adjustable optical element arranged to adjust the more than one beam of light from the more than one light source into more than one adjusted beam of light, with respective scattering patterns that are electrically variable.

This light module may further comprise a controller, for controlling, in response to an adjusting control signal, at least one element of a group of elements comprising one or more adjustable optical elements and one or more light sources by means of at least one driving signal.

Hence, according to a next aspect of the invention, a controller is provided for use in or for the light module, the controller being arranged to, in response to an adjusting control signal, controlling at least one element of a group of elements comprising one or more electrically adjustable optical elements and one or more light sources by means of at least one driving signal. The controller may control more than one light module.

According to yet another aspect of the invention, there is provided a computer program product to be run on a controller, the computer program product comprising the function of controlling, in response to an adjusting control signal, at least one element of a group of elements comprising one or more electrically adjustable optical elements and one or more light sources by means of at least one driving signal according to the invention.

Furthermore, according to another aspect of the invention, the invention enables the use of the light module according to invention as a multiple purpose light, especially as a multiple purpose interior car light.

Here, a light module comprising a light source and an electrically adjustable optical element (especially an electrically induced scattering element) is described, which can change the scattering of the beam of light upon application of an electric field. Advantageously, the use of an adjustable optical element for adjusting the scattering pattern provides the possibility of combining various functions in a single light module. In this way for example, a spot light or reading light, which is substantially unscattered, can be turned into a wide-beam comfort light, for example a low-intensity light with a broad distribution so that one can just see each other in the dark, or even further into an ultra-wide beam shape (stepping light or approaching light or general interior illumination light). Hence, a module is provided in an embodiment wherein the adjustable optical element is arranged to provide an adjusted beam of light comprising a beam with adjustable scattering properties in response to a driving signal.

Hence, a specific embodiment of the light module according to the invention can be used as a multiple purpose light, especially as a multiple purpose interior car light. The car may be provided with a light module such that the use of the light module is selected from the group consisting of reading light, vanity light, and stepping light. As will be clear to those skilled in the art, more than one light module may be provided. Advantageously, the adjustable optical element may be arranged to provide adjusted light comprising a beam with an adjustable cone angle and/or an adjustable direction since the scattering angles can be electrically varied. The light module according to the invention is not only applicable in cars, but may also be used in trucks, buses, airplanes, and trains, and may also be used for indoor and outdoor lighting, for devices like (pocket) lanterns, (pocket) torches, flash lights, illuminating lights, spectators, telescopes, (spy) glasses, still picture cameras, motion video cameras, mobile phones with camera functions, consumer devices like microwave ovens, washing machines, dishwashers, ovens, etc.

With this light module it is no longer necessary to shift a lens by hand for adjusting the light originating from the light source or to adjust the required intensity of light manually. Instead, the controller can adjust the luminous intensity and beam shape of the light originating from the light source(s) in a more automated manner. The module according to the invention is rendered more user-friendly thereby.

It should be noted that an object to be illuminated may be illuminated directly or indirectly, for example via reflections. The adjusting control signal is, for example, an electric signal, a magnetic signal, an electromagnetic signal, an optical signal, or an ultrasound signal.

The device according to the invention is of further advantage inter alia in that it offers an increased number of possibilities to a user, as will be discussed below.

In different embodiments, the light source may be arranged to provide continuous light (for example for a motion video camera), or may be arranged to provide flashing light (for example for a photo camera), or may be arranged to provide a combination of continuous light and flash light (for example for motion video and photo cameras) in response to a driving signal. A continuous light could also be applied when the light module is used, for example, as a torch lamp.

In another embodiment, the light source comprises sources as defined in claim 3, for example at least a light-emitting diode, a xenon lamp, or a halogen lamp. In an embodiment, light-emitting diodes (LEDs) are preferred as the source. Combinations of different sources may also be used. Advantageously, light-emitting diodes can be used for flashing as well as for non-flashing situations. The light source explicitly also includes an array of diodes. The array of diodes may be driven collectively or individually (for example by the controller).

In another embodiment, the adjustable optical element is arranged to provide adjusted light comprising a beam with an adjustable cone angle and/or an adjustable direction to optimize the illumination of a wide variety of objects.

In another embodiment, the adjustable optical element is arranged to provide adjusted light with an adjustable aspect ratio of the light beam, e.g. 4:3 or 16:9 aspect ratios, to adapt the beam shape to a selected aspect ratio of the movie or the photo to be taken. In yet another embodiment, the adjustable optical element comprises at least one element of the following group of optical elements comprising an electro-wetting lens, a liquid crystalline lens, a controllable scattering element, a controllable refraction element, and a reflection element. Here, a lens may comprise a single lens or a lens array. A collimation of a beam passing through a liquid crystalline element can be adjusted through the supply of, for example, an AC voltage with an adjustable amplitude to this element. The fluid in an electro wetting lens can be made convex or concave through the supply of, for example, an AC voltage with an adjustable amplitude to this lens. The avoidance of mechanical moving parts in adjusting the light leads to an improved device reliability compared with the prior art, making this invention even more user-friendly.

In another embodiment, the adjustable optical element comprises a liquid crystalline refractive index gradient element. Such an element is also known as a GRIN element.

In another embodiment, the adjustable optical element comprises at least one passive beam-shaping element and the controllable scattering element placed between the light source and the passive beam-shaping element. This claim explicitly includes the case of more than one passive beam-shaping element, with the controllable scattering element being placed between the passive beam-shaping elements. In yet another embodiment, the adjustable optical element comprises at least one passive beam-shaping element placed between the light source and the controllable scattering element.

In another embodiment, the adjusting control signal is generated by a user.

Embodiments of the controller according to the invention and of the computer program product according to the invention correspond with the embodiments of the light module according to the invention and are defined in claims 16 to 19.

The invention solves the problem of how to provide a light module and an optical device that can be relatively user-friendly and is furthermore advantageous in that it offers an increased number of possibilities to a user, as described above.

These and other aspects of the invention will be apparent from and elucidated with reference to the embodiments(s) described hereinafter with reference to the appended schematic drawings.

### BRIEF DESCRIPTION OF THE DRAWINGS

FIG. 1 schematically depicts a number of positions of interior car lights;

FIG. 2 diagrammatically shows a light module according to the invention comprising a controller according to the invention;

FIG. 3 diagrammatically shows a first embodiment of an adjustable optical element for adjusting light originating from a light source;

FIGS. 4a-4b diagrammatically show a second embodiment of an adjustable optical element for adjusting light originating from a light source;

FIGS. 5a-5b diagrammatically show a third embodiment of an adjustable optical element for adjusting light originating from a light source;

FIG. 6 diagrammatically shows a fourth embodiment of an adjustable optical element for adjusting light originating from a light source;

FIGS. 7a-7b diagrammatically show a fifth embodiment of an adjustable optical element for adjusting light originating from a light source;

FIG. 8 diagrammatically shows a sixth embodiment of an adjustable optical element for adjusting light originating from a light source;

FIGS. 9a-9b diagrammatically show a seventh embodiment of an adjustable optical element for adjusting light originating from a light source;

FIGS. 10a-10d show various electrode patterns which can be used in the embodiment shown in FIG. 9;

FIG. 11 shows a schematic configuration where the light source and passive beam-shaping elements and active elements can be combined for beam shaping and light distribution.

FIGS. 12a-12b schematically depict another embodiment of the light module according to the invention wherein the light module provides more than one beam of light.

FIG. 13 schematically depicts a modification of the embodiment schematically depicted in FIGS. 12a-12b.

### DESCRIPTION OF PREFERRED EMBODIMENTS

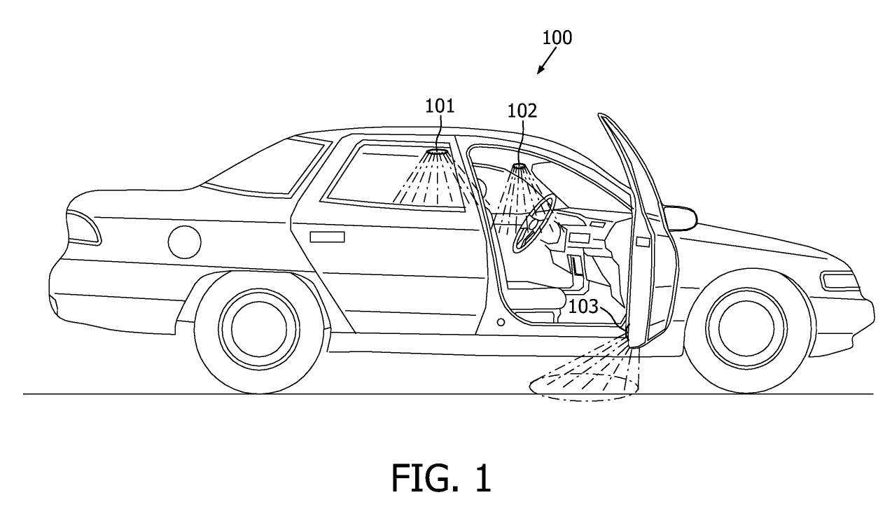

A large number of light sources are used for performing various interior lighting functions in present-day cars. Various spots are used as reading lights, and somewhat more diffuse lighting is used for vanity and comfort lighting. Lamps are also placed at the car doors to illuminate the stepping area into or out of the car. FIG. 1 shows embodiments of positions of various lamps used in a car 100, such as a vanity light 101, a reading light 102, and a stepping light 103. More positions of lights are possible, as will be clear to those skilled in the art, for example an interior light module against the inner car roof (for example arranged between the driver seat and passenger seat in the front or arranged above the back seat). State of the art lights cannot be used for multiple purposes. For example, a state of the art reading light 102 cannot be easily adapted to perform a stepping light function as well.

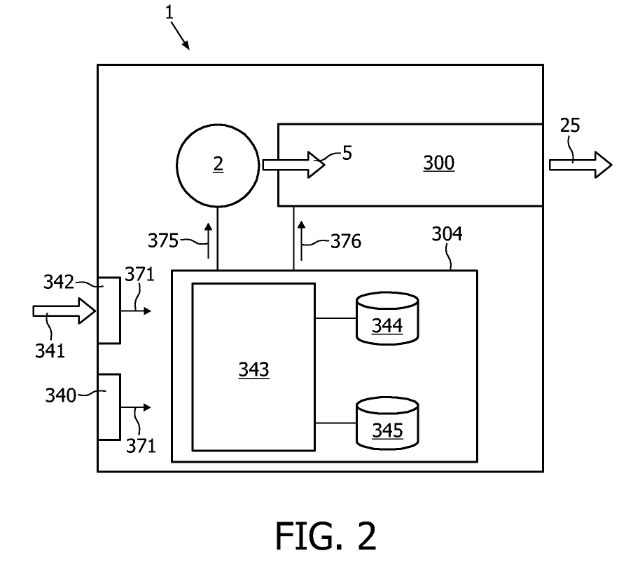

A light module 1 according to the invention is shown in FIG. 2, comprising a light source 2 for illuminating an object not shown and comprising an adjustable optical element 300. The light module 1 may further comprise a controller 304 arranged to control, in response to an adjusting control signal 371, at least one element of a group of elements comprising the electrically adjustable optical element 300 and the light source 2 by means of at least one driving signal 375, 376. An embodiment of light module 1 according to the invention comprises a light source 2 for illuminating an object (not shown) and comprises an electrically adjustable optical element 300 for adjusting light 5 originating from the light source 2 and for supplying adjusted light 25 to the object. A controller 304 controls the electrically adjustable optical element 300 by means of a driving signal 376 and/or the light source 2 by means of a driving signal 375 in response to an adjusting control signal 371. The driving signal 376 may comprise more than one driving signal, for example driving signals to control more than one optical element 300 (see below). The light source 2 is, for example, a flash light source or a continuous light source and may comprise a light-emitting diode, an array of diodes, a xenon lamp, or a halogen lamp.

In a preferred embodiment, the driving signal 375 for controlling the light source 2 is able to control (the intensity of) the light-emitting diodes of an array of light-emitting diodes individually in order to provide colored light 25, or light 25 with an adjustable color temperature if the array of diodes comprises diodes emitting light of different colors. In a specific embodiment, the controller 304 comprises a processor 343 coupled to an interface 340 for receiving the adjusting control signal 371, optionally to an input interface 342 for receiving the adjusting control signal 371 from a user 341, to, for example, a short-term memory 344, and/or to a long-term memory 345. The present light module 1 does not require, for example, a manual shifting of a lens for adjusting the beam of light 25 originating from light source 2, or a manual adjustment of the required intensity of light (although the latter may still optionally be done, see below). Instead, the controller 304 offers the possibility of adjusting the luminous intensity, scattering properties, and/or beam shape of the beam of light 25 originating from the light source 2 in a more automated manner. As a result, the light module 1 according to an embodiment of the invention is more user-friendly. Alternatively and/or in addition, the further adjusting control signal 371 is generated, for example, by the user to inform the controller 304 (in an embodiment the processor 343) of the user's preferences. The luminous intensity may be controlled by adjusting the power delivered to the light source 2 and/or the voltage applied across the electrically adjustable optical element 300.

The controller may be accommodated in the same module as the light source and the adjustable optical elements, but it is also possible to have it at a different place within the car.

The adjustable light 25 may also be used to highlight objects, to achieve optimized illumination of different objects, to change the beam shape of illuminated areas as a function of a viewing angle, or to adapt the beam shape to aspect ratios of e.g. video or photo cameras.

Alternatively and/or in addition, the further adjusting control signal 371 is generated, for example, by the user to inform the controller 304 (the processor 343) of the user's preferences.

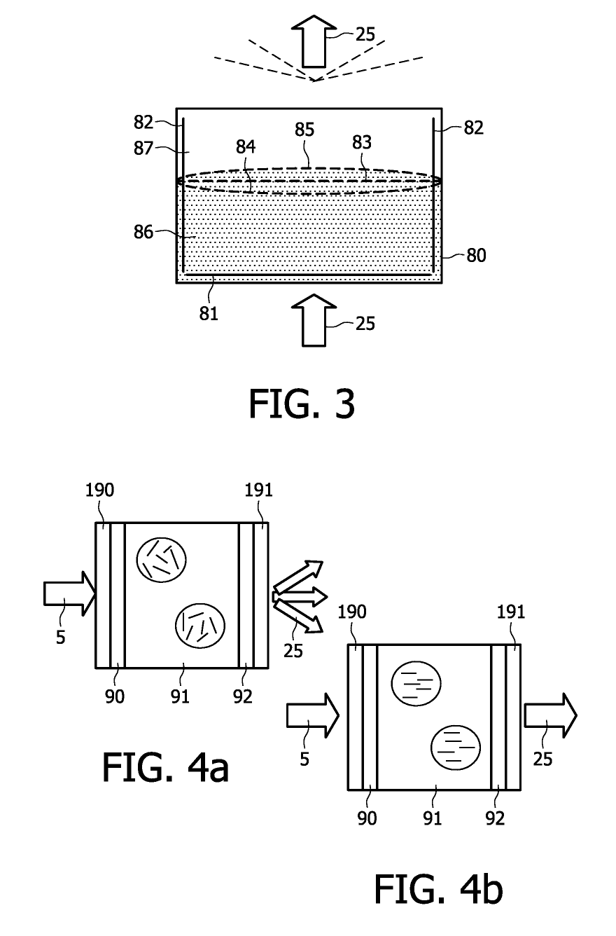

The adjustable optical element 300 may comprise, for example, a fluid focus lens (array) 80 as shown in FIG. 3. For example, the supply of an AC voltage having an adjustable amplitude to a polar liquid 86 of the fluid focus lens (array) 80 via conductors 81 and 82 causes a meniscus to be formed at an interface of the polar liquid 86 and an apolar liquid 87. This meniscus has three different modes 83, 84, 85 comprising a convex mode and/or a concave mode that may have adjustable amplitudes. The cone angle of the outgoing light 25 can be thus adjusted in dependence on the cone angle of the incoming light 5.

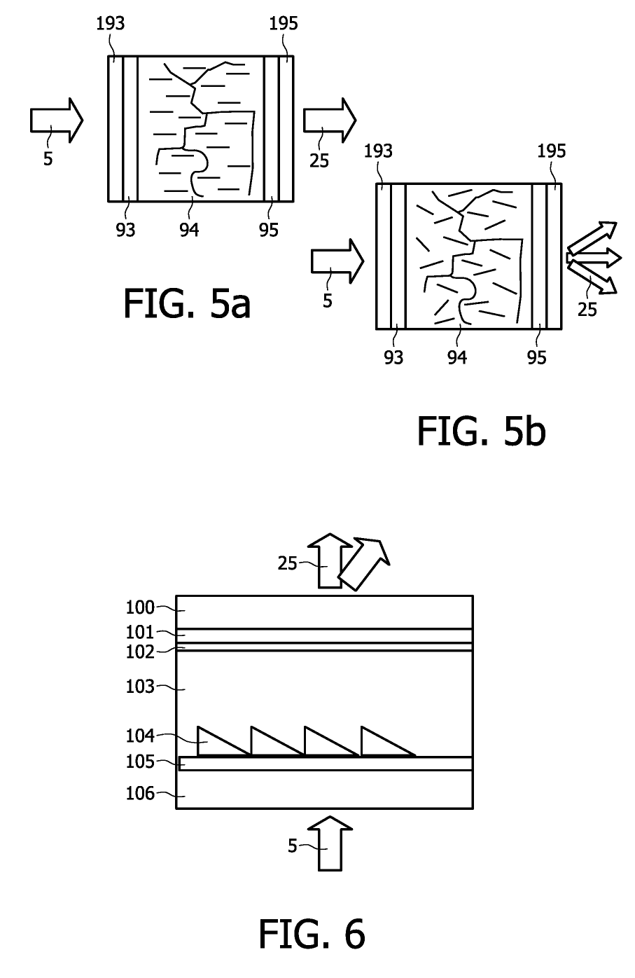

The adjustable optical element 300 may comprise, for example, various liquid crystalline materials as shown in FIGS. 4a-b and 5a-b. FIG. 4 shows a material 91 which scatters light without any voltage. In other words, when a zero volts signal is supplied to transparent electrodes 90 and 92 present on substrates 190 and 191, the incoming light 5 is scattered (FIG. 4a), and, when a sufficiently high voltage is supplied, the material 91 becomes transparent (FIG. 4b) so as to produce (substantially) unscattered light. FIGS. 5a-b show another material which is transparent without a voltage being applied (FIG. 5a). When the voltage across the transparent electrodes 93 and 95 present on substrates 193 and 195 is zero, the material 94 is transparent (FIG. 5a), and, when a sufficiently high voltage is applied across the electrodes, the incoming light 5 becomes scattered (FIG. 5b).

The adjustable optical element 300 may comprise, for example, a liquid crystalline material as shown in FIG. 6. From top to bottom, a glass substrate 100, a transparent electrode 101, an orientation layer 102, liquid crystalline material 103, an isotropic layer 104, a transparent electrode 105, and a glass substrate 106 are present. By supplying a zero volts signal or a non-zero volts signal, the incoming light 5 is or is not refracted owing to the fact that the application of an electric field alters the orientation of the liquid crystal molecules, and the light beam can pass without getting refracted.

If both polarization directions need to be affected, two such elements need to be used in a configuration where the orientations of liquid crystal molecules in the elements are mutually perpendicular. The orientation direction of the molecules can be kept the same, but in that case a half-wave plate needs to be inserted between the elements.

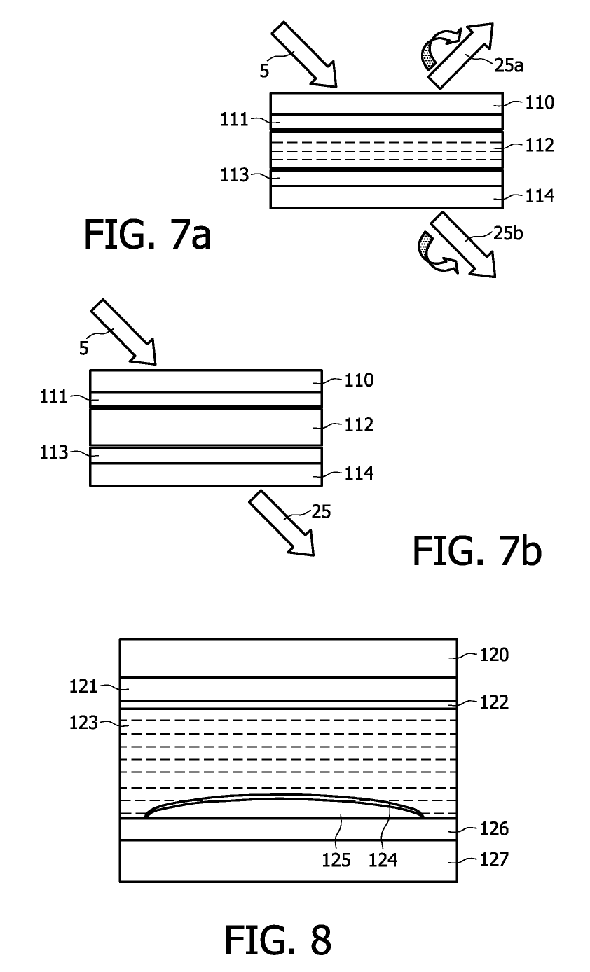

The adjustable optical element 300 may comprise, for example, a so-called chiral liquid crystalline material as shown in FIGS. 7a-b. In a zero voltage state, a liquid crystal 112 reflects a band of circularly polarized light 25a, whereas a band of circularly polarized light 25b of opposite electric field is transmitted (FIG. 7a). A voltage across the transparent electrodes 111 and 113 placed on top of the glass substrates 110 and 114 removes a helical structure of the liquid crystal 112 and makes the cell transparent (FIG. 7b). A double cell configuration can be used to reflect both polarization directions. In this configuration, one of the possibilities is to use cells containing chiral materials reflecting left and right polarization directions of circularly polarized light. The other possibility is to use identical chiral materials containing cells with a half-wave plate in between.

The adjustable optical element 300 may be a liquid crystalline lens as shown in FIG. 8 with a curvature present within the cell structure 125. This structure 125 works as a lens if it is made of an isotropic material with a refractive index that is almost the same as one of the refractive indices of the liquid crystal in its zero voltage state. The application of a voltage across the transparent electrodes 121 and 126 placed on top of the glass substrates 120 and 127 reorients liquid crystal molecules 123, and the lens effect disappears. The transparent electrode 121 is covered by an orientation layer 122 and the structure 125 is covered by an orientation layer 124. If the structure 125 is made of an anisotropic material with refractive indices almost the same as the refractive indices of the liquid crystal in its zero voltage state, then no lens action is present. The application of a voltage across the transparent electrodes 121 and 126 placed on top of glass substrates 120 and 127 liquid reorients crystal molecules 123, and the lens effect appears. A single element can work with only one linear polarization direction, so two elements are needed to influence both polarization directions. This is an example of a single lens, but it is also possible to make a lens array using such structures.

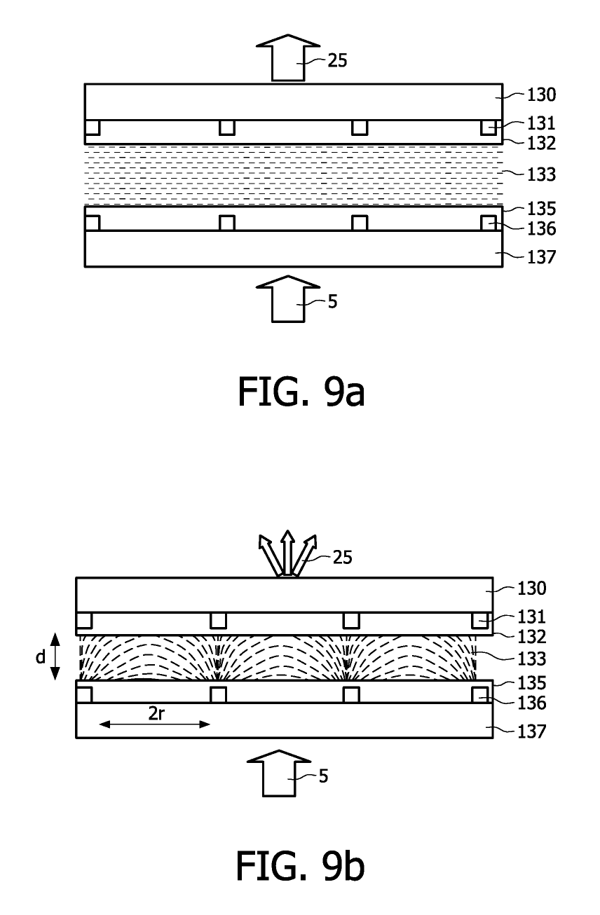

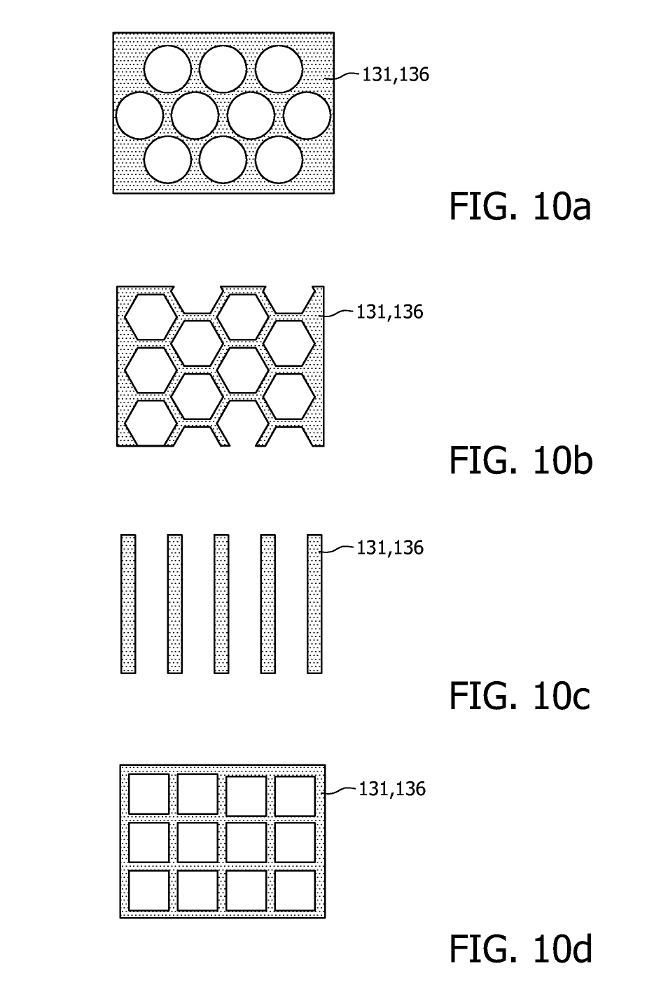

The adjustable optical element 300 may be a liquid crystalline refractive index gradient (GRIN) lens or array as shown in FIGS. 9a-b. Such an element comprises patterned electrodes. If both surfaces of the cell contain patterned electrodes, the surfaces are aligned with respect to one another such that the patterns show an almost perfect overlap. In this situation the potential is highest between the electrodes. Outside the electrodes, field lines leak outside the cells resulting in non-uniform field lines. As a result, a refractive index gradient is formed in the area containing no electrodes. If the transparent electrodes contain circular holes (see also FIG. 10a), spherical lenses are formed, whereas the use of linear electrodes at a periodic distances can induce cylindrical lenses. The electrode geometry may also take other forms, examples of which are shown in FIGS. 10b-d. FIG. 9 shows a cell with patterned electrodes (131,136) on glass substrates (130,137) containing a liquid crystal (133). Macroscopic orientation of liquid crystal molecules is induced with orientation layers (132,135) made of rubbed polymer layers. Patterned electrodes may have any structure, and various examples are shown in FIGS. 10a-d. When the applied voltage across the electrodes (131,136) is zero, liquid crystal molecules are oriented uni-axially and there is no lens action within the cell, as is shown in the top drawing of FIG. 9, where the beam 5 passes through the cell without being altered. The application of an electric field across the cell as shown in the bottom drawing of FIG. 9 results in a reflective index gradient being induced in the region between the electrodes, and the path of the light beam 5 is altered.

In another embodiment, the GRIN lens can be produced from a cell in which an electrode pattern is provided on only one of the surfaces and the other surface does not contain any pattern. In yet another embodiment, the patterned electrode(s) is (are) covered by a layer with a very high surface resistance in the Mega Ohm/square range.

The GRIN lenses described above also show polarization dependence. If both polarization directions need to be affected, two such elements need to be used in a configuration where the orientations of the liquid crystal molecules in the elements are mutually perpendicular. The orientation direction of the molecules can be kept the same in both elements, but in that case a half-wave plate needs to be inserted between the elements.

In this application it is important to have low losses caused by reflections and absorption. The GRIN concept described above can minimize these losses so that a higher transmission can be obtained.

The isotropic scattering properties can be obtained in a number of ways. An optical element 300 is preferably selected which comprises a liquid crystal cell containing a liquid crystal material selected from the group comprising an LC gel (liquid crystal gel) with negative dielectric anisotropy, a chiral gel, and a PDLC (polymer dispersed liquid crystal) material (see also below).

As will be clear to those skilled in the art, the adjustable optical element 300 may comprise more than one of the adjustable elements described herein. Furthermore, the optical element 300 may in addition contain other optical elements such as, for example, mirrors, lenses, but also detectors or sensors for controlling the beam properties of beam 25, which detectors or sensors may send a signal to the controller 304 such that the beam can be adjusted or controlled.

Thus an adjustable optical element 300 that can change the light distribution, scattering properties, and/or its shape can be placed in front of a collimated light source 2.

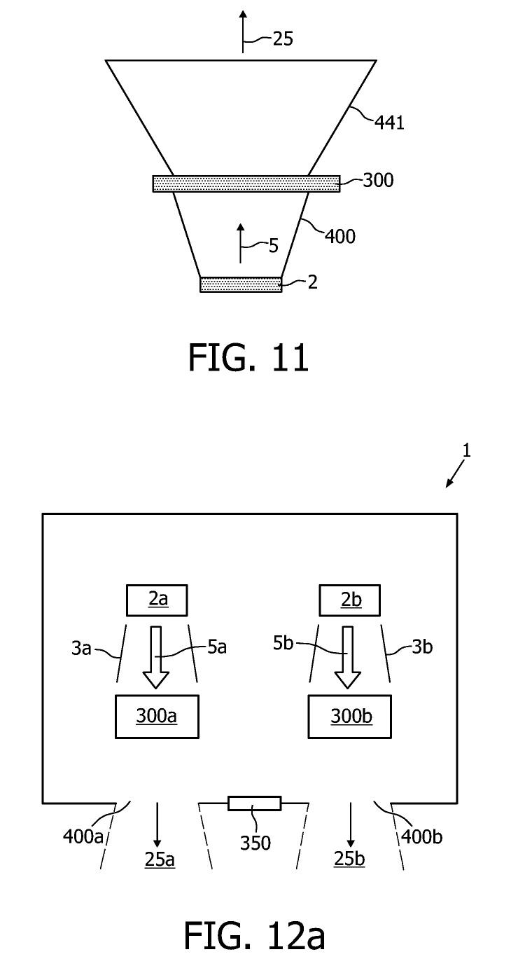

The adjustable optical element used for collimating and shaping the light, however, may also be placed between the light source 2 and one passive beam-shaping element or, in the case of more than one passive beam-shaping element, between the passive beam-shaping elements, for example. If a light-emitting diode is used the as a light source 2, for example, a reflector 440 and/or 441 with a certain shape may be used in order to obtain a light shape with a certain distribution. The adjustable optical element 300 can therefore be placed between the passive beam-shaping elements 440 and 441 as shown in FIG. 11. The passive beam-shaping elements may also consist of several segments, and the adjustable optical element 300 may be placed in any location along the passive beam-shaping elements 440 and 441. Note that FIG. 11 only shows the source, adjustable optical element 300, and passive beam-shaping elements 440 and 441. Other elements, such as a controller 304, etc, are not shown in this Figure.

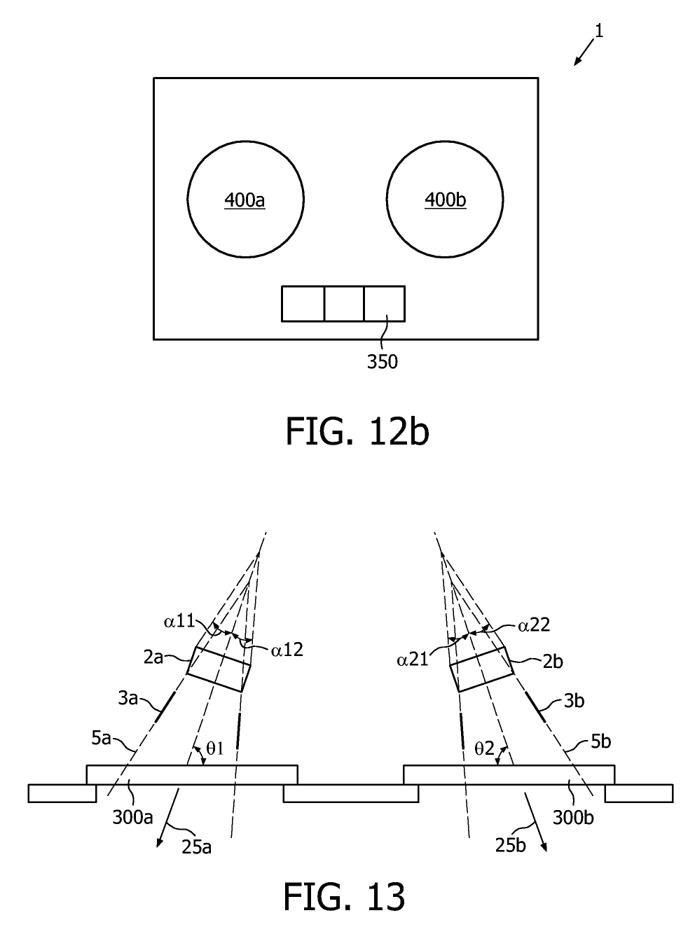

In a further embodiment, one or more passive beam-shaping element(s) are present between source 2 and adjustable element 300 as shown, for example, in FIGS. 12a and 12b (which will be described below).

It is also possible to segment the electrodes of the adjustable optical element to obtain a better control over the beam shape.

In another embodiment, a switching from direct lighting to indirect lighting and vice versa may be used. In that case, light originating from a source is partly or totally reflected so that it reaches the object after being reflected, for example, by the ceiling. In this way the object is indirectly illuminated.

Various examples of liquid crystalline lenses based on curved surfaces can be found in the patent literature (U.S. Pat. No. 4,190,330, WO200459565), Fresnel lenses, and zone plates made of patterned electrodes. It is possible to adjust the collimation of a beam by supplying, for example, an alternating current voltage with an adjustable amplitude to a liquid crystalline element. Lenses can be based on a principle of electro wetting (WO0369380). The supply of an AC voltage of adjustable amplitude to an electro wetting lens can make the fluid convex or concave. The cone angle of the outgoing light can be adjusted thereby. Another embodiment of the light module according to invention is scattering and/or diffracting in an electrically controllable manner. Effects based on polymer dispersed liquid crystals are common in the art. Gels (U.S. Pat. No. 5,188,760) can be used for this purpose. It is also possible to change a direction of light in an element where a blazed grating structure is filled by liquid crystals, and electric signals are used to control the orientation of liquid crystal molecules (U.S. 60/14197). Switchable reflectors (U.S. Pat. No. 5,798,057, U.S. Pat. No. 5,762,823) may also be used in order to change a direction of the light. The adjustable optical element may alternatively comprise a switchable graded index liquid crystal element.

The module may further comprise one or more switches or one or more sensors or one or more switches as well as one or more sensors, wherein the switches provide one or more functions selected from the group comprising:

switching source 2 on and off;

electrically adjusting electrically adjustable optical element 300, (for example, the passenger adjusting the source from comfort light (scattered) to reading light (focused);

adjusting the scattering properties of the beam of light 25;

adjusting the luminous intensity of the beam of light 25;

and wherein the sensors provide one or more functions selected from the group comprising:

detecting one or more of the states: opening, closing, locking, and unlocking of one or more doors;

detecting a remote signal indicating one or more of the states: opening, closing, locking, and unlocking of one or more doors;

detecting the presence of a driver and/or one or more passengers;

detecting driving (for example for giving a signal 376 to block the non-scattering function for a beam 25 of light directed to the driver);

detecting a remote control signal intended to control one or more of the same functions as described above for the switches (i.e. switching source 2 on and off; electrically adjusting electrically adjustable optical element 300; adjusting the scattering properties of the beam of light 25; adjusting the luminous intensity of beam of light 25 (for example a sensor sensing a remote control giving a signal indicating a change from reading light (unscattered or substantially unscattered) to comfort light (scattered) of the same beam 25)).

According to yet another embodiment, as schematically depicted in FIGS. 12a and 12b, the light module 1 according to the invention provides more than one beam of light 25, here indicated with reference numbers 25a and 25b, wherein the light module 1 preferably comprises more than one source 2, indicated with 2a and 2b, arranged to provide more than one beam of light 5 (indicated with 5a and 5b) and more than one electrically adjustable optical element 300, indicated with reference numbers 300a and 300b arranged to adjust the more than one beam of light 5 from the more than one light source 2 into more than one adjusted beam of light 25a and 25b, respectively. The scattering patterns of the adjusted beams of light 25 are electrically variable. Preferably, the scattering pattern of each of the beams of light is individually adjustable (controllable). Adjusted beams of light can thus be provided with desired scattering properties (from unscattered to scattered).

As will be clear to those skilled in the art, one may use one source and one or more beam splitters or other means known to those skilled in the art, to provide more than one beam of light 5. Preferably, each beam of light 5 (5a, 5b, etc.) is addressed individually by an adjustable optical element 300 (300a, 300b, etc.), such that controllable beams of light 25 (i.e. 25a, 25b, etc.) are provided by the module.

Hence, the terms “beam of light 25”, “driving signal 375”, “driving signal 376, “source 2”, “collimator 3”, “beam of light 5”, etc. as used herein are also deemed to denote “beams of light 25”, “driving signals 375”, “driving signals 376, “sources 2”, “collimators 3”, “beams of light 5”, etc., respectively, as well as “at least one of the beams of light 25”, “at least one of the driving signals 375”, “at least one of the driving signals 376, “at least one of the sources 2”, “at least one of the collimators 3”, “at least one of the beams of light 5”, etc., respectively.

FIG. 12a schematically depicts a module having two sources 2a and 2b, although more sources may be used (for example to provide a module with 3 beams of light 5 and resulting beams of light 25). The beam of light 5 from the sources 2a, 2b may optionally be collimated with collimators 3, indicated with reference numbers 3a and 3b. The beams of light 5a and 5b are interrupted by electrically adjustable optical elements 300 (i.e. 300a and 300b, respectively), such that the properties of the beams of light 25a and 25b can be controlled. Reference number 400 (here reference numbers 400a and 400b) denotes the location in the module 1 where the beams of light 25 are passed to the exterior of the module 1 and are also called exit(s) 400. This may be, for example, a lens, a transparent glass plate, a transparent plastic or polymer cover, it may be a transparent glass plate of a cell containing the LC molecules (for example from cell 20), etc. As will be clear to those skilled in the art, exit(s) 400 may have all kinds of suitable shapes, like round, square, elliptical, etc.

A light module 1 is thus provided which supplies more than one beam of light 25, the light module 1 preferably comprising more than one source 2 arranged to provide more than one beam of light 5; and more than one electrically adjustable optical element 300 arranged to adjust the more than one beam of light 5 from the more than one light source 2. The term “more than one” is equivalent to “two or more”. Preferably, the module provides 2 to 6, more preferably 2 to 4, even more preferably 2 to 3 beams of light 25 whose properties are electrically variable in the sense that, amongst other properties, their intensity and scattering can be controlled.

Furthermore, the module 1 may comprise one or more sensors and/or one or more switches 350. These sensors or switches 350 may be present on or in the module 1, but may also be present, for example, on a dashboard of a car or elsewhere. For example, module 1 for use in a car may comprise a sensor 350 located in the door or doorways of the car and arranged to sense, for example, the opening, closing, locking, or unlocking of the door. The sensor provides a signal 371 which may used by controller 304 to switch on one or more of the lamps 2a, 2b and provide beams of light 25a and 25b, which may be, for example, scattered (approaching light function) by the driving signal 376 (and 375). The module 1 may alternatively or in addition comprise a sensor that senses a remote unlocking of the door(s). While driving, a beam of light 25 directed to the driver may be scattered according to the invention, such that the driver may not be dazzled. A person next to the driver may use the other beam of light, for example unscattered, to read.

Assuming, for example, that the module comprises switches 350, for example three switches (as schematically indicated in FIG. 12b), the switches may be used to switch on various elements. With a first switch, both sources 2a,2b (for example LEDs) can be switched on while at the same time the scattering state of LC cell is activated (providing comfort light and approaching light functions). There may optionally be a control that enables the sources 2a, 2b to be switched on when the central door key is activated while at the same time the scattering state of LC cell (approaching light function) is switched on. The other switches may be used to switch lamp 2a (a second switch) and lamp 2b (a third switch) on and off individually, respectively, when the scattering function is deactivated (reading light function). As will be clear to those skilled in the art, one may also use one switch, for example a touch control, etc., providing a number of functions, supported by controller 304. For example, one touch: both sources 2a, 2b (for instance LEDs) can be switched on and at the same time the scattering state of LC cell is activated; two/three touches: lamp 2a and lamp 2b, respectively, are switched on and off individually when scattering function is deactivated; four touches: all lamps off.

As will be clear to those skilled in the art, the switches may be, for example, touch switches or slide switches, which may provide multiple functions (see above) for the multiple purpose light (for example for addressing both sources at the same time and both sources individually) and may be variable switches. In this way a user 341 may give a signal 371 to a controller 304, which can then address the sources 2 by means of driving signals 375 and the adjustable elements 300 by means of driving signals 376 (see also FIG. 2).

In general, the module 1 in this embodiment and variations thereof comprise sources 2 arranged to generate two or more beams of light 5, optionally two or more collimators 3 arranged to collimate the two or more beams of light 5, two or more electrically adjustable optical elements 300 arranged to adjust the two or more beams of light 5 from the two or more light sources 2, thereby providing two or more beams of light 25 with electrically variable scattering patterns. The module further comprises one or more switches or one or more sensors 350, or one or more switches as well as one or more sensors 350, wherein the switches provide one or more functions selected from the group comprising:

switching sources 2 on and off, preferably each source of the two or more sources individually (for example, a passenger switching his source on and off only, for example for reading a map);

switching on and off the two or more sources on and off at the same time (for example switching on all sources 2 at the same time);

electrically adjusting the two or more electrically adjustable optical elements 300, preferably each switch (i.e. variable switch) of the two or more switches adjusting one of the two or more electrically adjustable optical elements 300 individually (for example the passenger adjusting the source from comfort light (scattered) to a reading light (focused);

adjusting the scattering properties of the two or more beams of light 25;

adjusting the light intensity of the two or more beams of light 25; and wherein the sensors provide one or more functions selected from the group comprising:

detecting one or more of the states: opening, closing, locking, and unlocking of one or more doors;

detecting a remote signal indicating one or more of the states: opening, closing, locking, and unlocking of one or more doors;

detecting the presence of a driver and/or one or more passengers;

detecting movement (or movements), for example driving (used, for example, to block the non-scattering function for a beam of light directed to the driver);

detecting a remote control signal intended to control one or more of the same functions as described above for the switches (for example a sensor sensing a remote control giving a signal indicating a change from reading light (unscattered or substantially unscattered) to comfort light (scattered) of the same beam 25).

Hence, the light module 1 according to the invention may further comprise one or more switches or one or more sensors 350, or one or more switches as well as one or more sensors 350, wherein the one or more switches (350) provide one or more functions selected from the group comprising: switching one or more sources 2 on and off; optionally switching one or more sources 2 on and off at the same time (if more than one source is present); electrically adjusting one or more electrically adjustable optical elements 300; adjusting the scattering properties of one or more beams of light 25; adjusting the luminous intensity of one or more beams of light 25; and wherein the one or more sensors 350 provide one or more functions selected from the group comprising: detecting the opening, and/or closing of one or more doors; detecting a remote signal indicating the opening, closing, locking, and unlocking of one or more doors; detecting the presence of a driver and/or one or more passengers; detecting movement (for example driving); detecting a remote control signal intended to control one or more of the functions described for the switches 350.

In general, such a module 1 may be intended to be arranged on an inner roof part of a car, with the beams of light directed to the driver seat and to one or more passenger seats, or to be arranged on an inner roof part of a car, with the beams of light directed to back seats. As will be clear to those skilled in the art, module 1 may comprise more than two sources 2, for example a module intended for arrangement in a car in which three persons sit in a row, as is the case in some cars, or in the back seat of a car, or, for example, a module intended for arrangement in an airplane over a row of seats. If the module is intended for arrangement in a car with a beam of light directed to the driver, it is preferred that at least the optical module 300 for controlling the beam of light 25 directed to the driver can provide an anisotropic light distribution when the car is being driven.

The term “controller” as used herein may refer to an on/off switch, a variable switch, or a controller such as a computer, said controller comprising a processor and, for example, one or more sensors having functions selected from the functions described above.

A specific modification is shown in FIG. 13, wherein two sources 2a and 2b are used, and the beams of light produced by these sources 2a and 2b are preferably collimated by respective collimators 3a and 3b.

Preferably, the collimators 3a and 3b are arranged and designed such that, when arranged in a car or airplane, etc., they illuminate an A4 area present on a seat. The collimation angles α₁₁/α₁₂ of collimator 3a preferably lie each between approximately 10° and 20°, for example being 15°. The same applies to collimator 3b (α₂₁/α₂₂). The sources 2a and 2b and collimators 3a and 3b may be arranged such that central beams in the beams of light enclose angles θ₁ and θ₂ with the electrically adjustable optical elements 300a and 300b, respectively. In an embodiment, θ₁ and θ₂ are chosen such that they provide a beam of light to a driver seat in a car and to a passenger seat in a car, respectively. As will be clear to those skilled in the art, module 1 may comprise more sources 2, collimators 3, and optical elements 300, for example for providing beams of light to 3 for more persons, for example in a row of seats in an airplane or for an arrangement above the back seats in a car.

Preferably, at least one of the electrically adjustable optical elements 300a and 300b comprises an LC cell which is selected and arranged so as to be able to provide isotropic scattering. More preferably, both (all) electrically adjustable optical elements 300a and 300b comprise LC cells which are selected and arranged so as to be able to provide isotropic scattering. This means that beam 5 from source 2 is converted into a beam 25 with an isotropic scattering pattern. The scattering properties may be selected in dependence on the type of light desired (see further below).

The isotropic scattering properties can be obtained in a number of ways. Preferably, at least one of the (more than one) adjustable optical elements (300) comprises a liquid crystal cell containing a liquid crystal material selected from the group comprising an LC gel with negative dielectric anisotropy, a chiral LC gel, and a PDLC (polymer dispersed liquid crystal) material.

In a preferred embodiment, the LC cell comprised in optical element 300 is based on an LC gel with negative dielectric anisotropy. In the cell, the director is oriented perpendicularly to the surfaces of the cell (i.e. the surface that directly receives the beam of light 5). In the field-off state, the cell is transparent; the application of an electric field induces scattering. In this way an electrically adjustable optical element is provided, which provides to the module 1 the option of a beam with an isotropic scattering pattern or no or substantially no scattering, depending on the applied electric field.

An alternative to this type is a chiral gel. In such a gel the director is parallel to the cell surface but performs several rotations from one surface to the other. The material has a positive dielectric anisotropy. In the field-off state there is no scattering; the cell starts scattering light upon application of a voltage. This again provides an electrically adjustable optical element affording the module 1 the option of a beam with an isotropic scattering pattern or no or substantially no scattering, depending on the applied electric field.

In yet another embodiment, the material in the LC cell in (one or more of the) electrically adjustable optical element(s) 300 is based on a so-called PDLC (polymer dispersed liquid crystal) schematically shown in FIGS. 4a and 4b. As is known to those skilled in the art, a way to obtain PDLC is to make a mixture of LC and a photo-polymerizable monomer. The mixture is isotropic. Upon polymerization, a phase separation occurs leading to a structure with LC droplets in a polymer matrix. The cell is scattering in the field-off state. The application of a voltage makes the cell transparent. PDLC materials are described, for example, in U.S. Pat. No. 4,688,900.

Systems which in the transparent state are transparent at all angles are preferred to systems which in the “transparent” state still show some haze at, for example, wider angles. In most known PDLC systems, for example, liquid crystal molecules are confined in droplets in a polymer matrix. In the electric field-off state, LC molecules are randomly oriented with respect to each other in various droplets, and there is a refractive index mismatch in almost all directions between the refractive indices of the LC and the polymer matrix. The application of the electric field orients the LC molecules in the direction of the electric field. The ordinary refractive index of LC is chosen such that it matches the refractive index of the polymer. As a result, no light scattering takes place for light prorogating in the direction of the applied field, and the system appears to be transparent. At wider angles, light starts to be increasingly influenced by the extraordinary refractive index of the liquid crystal, and this results in the appearance of scattering.

Interpenetrating network types of PDLC also show less haze at wider angles, as less polymer-LC interface is present with respect to droplet type PDLC in such systems.

Gels on the other hand are transparent in the field off state as refractive indices are matched in all directions. They scatter light upon the application of an electric field.

It is also possible to add dye molecules, which may optionally also be luminescent, to the gel or PDLC samples, as described in WO2005101445. In that way scattering can be combined with increased absorption (and/or luminescence), leading to a color change of scattered light.

At least one adjustable optical element 300 comprises one of the above-mentioned LC systems for providing a beam with isotropic scattering. More preferably, all beams 5 (assuming a module provides two or more beams 25) are intercepted by optical element 300 providing the function of selecting isotropic scattering or non-scattering of beam 25.

The embodiments claimed in claims 2 to 11 and described above for the module 1 providing one beam of light 25 are also applicable to the module providing more than one beam of light 25 and may be applicable to one or more beams of light 25 of the module 1. For example, a module comprising two sources 2 may comprise beam-shaping elements 440, 441 (see FIG. 11) for one or both sources.

Furthermore, the invention also provides a controller 304 as described above for use in light module 1, the controller 304 being arranged to control, in response to an adjusting control signal 371, at least one element of a group of elements comprising one or more adjustable optical elements 300 (of the more than one electrically adjustable optical element 300) and one or more light sources 2 (of the more than one light source 2) by means of at least one driving signal 375, 376. The invention further provides a computer program product to be run on a controller 304, the computer program product comprising the function of controlling, in response to an adjusting control signal 371, at least one element of a group of elements comprising one or more adjustable optical elements 300 (of the more than one electrically adjustable optical element 300) and one or more light sources 2 (of the more than one light source 2) by means of at least one driving signal 375, 376.

Hence, the light module may be based, for example, on an anisotropic liquid crystal gel, which is described in, amongst other documents, EP0451905 and U.S. Pat. No. 5,188,760, which are incorporated herein by reference. The term “anisotropic liquid crystal gel” denotes a system known to those skilled in the art and is obtainable as follows: a liquid crystalline mixture containing a polymerizable component (monomer which can yield a cross-linked polymer upon polymerization) and non-polymerizable component (conventional LC used in displays) is formed. For photo-polymerization, the system is provided with a photo-initiator, whereas for thermal polymerization the system is provided with a thermal initiator. The LC mixture is then placed in a suitable cell where macroscopic orientation in the LC is induced by orientation layers, which are brought onto the cell surfaces. An anisotropic gel is obtained through polymerization of the monomer in the macroscopically oriented state. An anisotropic gel thus is a system in which the LC molecules are macroscopically oriented and the polymer (polymerized network) is dispersed within the system. Such a gel is (substantially) transparent to light incident at all angles.

The term “liquid crystal gel” (LC gel) as used herein refers to a gel in which a polymer is dispersed within a macroscopically oriented liquid crystal, as is known to those skilled in the art. For example, (photo)curable monomer is mixed in a LC host. The mixture is then injected into an LC cell with the proper surface treatment followed by (photo)polymerization of the (photo)curable monomer in the monomer and LC host mixture.

For example, anisotropic gels may be produced by photo-polymerization of an oriented liquid crystalline (LC) mixture containing LC diacrylates and conventional LC molecules. In the voltage-off state, the gel is transparent or substantially transparent owing to the ordered molecular alignment. When the voltage exceeds a threshold, the torques exerted by the electric field on the LC molecules cause their reorientation, leading to the formation of domains with different orientations of the LC molecules. This variation in the orientation of molecules in different domains causes refractive index fluctuations leading to scattering of light. Light incident on such an anisotropic gel can be scattered either isotropically in all directions, or preferentially (anisotropically) in a certain direction (range of angles), depending on the orientation and/or configuration of the LC molecules, as is known to those skilled in the art. The term anisotropic light distribution or anisotropic scattering pattern used herein refers to a scattering pattern where iso-intensity lines (lines connecting points of equal intensity) do not form circles; the term isotropic light distribution or isotropic scattering pattern refers to a scattering pattern where iso-intensity lines (lines connecting points of equal intensity) do form circles, as is known to those skilled in the art.

The term “director” used herein refers to the molecular direction of preferred orientation in liquid crystalline mesophases. The term “mesophase” refers to an equilibrium liquid crystalline phase formed with a less than three-dimensional order (like crystals) and a mobility less than that of an isotropic liquid. Parallel orientation of the longitudinal molecular axes is common to all mesophases (long-range orientation order). The term “twisted nematic” (TN) refers to a type of liquid crystal orientation configuration where the LC molecules rotate through 90° from one surface to the other surface. The term “super twisted nematic” (STN) refers to a type of liquid crystal in which the liquid crystal molecules rotate through more than 90° in the cell. Furthermore, the term “cholesteric liquid crystals” refers to an LC crystal phase which is doped with so-called chiral molecules which induce rotation in LC molecules. This phase is also known as chiral nematic. In the cholesteric phase, the distance over which the director rotates 360° is the pitch of the helix. Usually, the pitch of the helix becomes smaller as the chiral molecule concentration within the system increases.

In a specific embodiment, the light module 1 may provide a scattering pattern of the beam 25 (or of at least one beam 25 if a module 1 is used that provides more than one beam 25) with an anisotropic light distribution.

The light module may also be called an illumination device (for illuminating an object) herein.

As will be clear to those skilled in the art, the phrase “a light module comprising a controller” or “the light module comprising a switch or sensor” also includes embodiments wherein the controller 304, switch or sensor 350 are remote from the light source (and adjustable element 300). For example, the module 1 comprising the light source 2 and the adjustable element may be arranged at the inside of a car roof, and the switch or sensor 350 may be placed on a dashboard, etc. One controller 304 may control more than one module 1, for example controlling a number of lights 2 by means of signal 375 and adjustable elements 300 arranged in a number of locations in a car or airplane, etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A light module (1) comprising:
a light source (2) for emitting a beam of light (5);
an adjustable optical element (300) for adjusting the beam of light (5) originating from the light source (2) into an adjusted beam of light (25) with a scattering pattern that is electrically variable; and
a controller (304) for controlling, in response to an adjusting control signal (371), at least one element of a group of elements comprising the adjustable optical element (300) and the light source (2) by means of at least one driving signal (375, 376).

2. The light module (1) according to claim 1, wherein the light source (2) is arranged to provide the beam of light (5) in response to a driving signal (375) so as to comprise continuous light or flash light.

3. The light module (1) according to claim 1, wherein the source (2) is selected from one or more of the group consisting of a halogen lamp, a xenon lamp, an LED, and a luminescent lamp.

4. The light module (1) according to claim 1, wherein the adjustable optical element (300) is arranged to provide the adjusted beam of light (25) in response to a driving signal (376) so as to comprise a beam with adjustable scattering properties.

5. The light module (1) according to claim 4, wherein the adjustable optical element (300) is arranged to provide the adjusted beam of light (25) in response to a driving signal (376) so as to comprise a beam with isotropic scattering properties.

6. The light module (1) according to claim 1, wherein the adjustable optical element (300) is arranged to provide the adjusted beam of light (25) with an adjustable aspect ratio of the light beam in response to a driving signal (376).

7. The light module (1) according to claim 1, wherein the adjustable optical element (300) comprises at least one element from the group of optical elements comprising: an electro wetting lens, a liquid crystalline lens, a controllable scattering element, a controllable diffraction/refraction element, and a reflection element.

8. The light module (1) according to claim 1, wherein the adjustable optical element (300) comprises a liquid crystalline refractive index gradient element.

9. The light module (1) according to claim 1, wherein the adjustable optical element (300) comprises at least one passive beam-shaping element (440, 441) with the controllable scattering element being placed between the light source (2) and the passive beam-shaping element.

10. The light module (1) according to claim 1, wherein the adjustable optical element (300) comprises a liquid crystal cell containing a liquid crystal material selected from the group comprising: an LC gel with negative dielectric anisotropy, a chiral gel, and a PDLC (polymer dispersed liquid crystal) material.

11. The light module (1) according to claim 1, wherein the adjusting control signal (371) is generated by a user (41).

12. The light module (1) according to claim 1, wherein the module provides more than one beam of light (25), the light module (1) preferably comprising:
more than one source (2) arranged to provide more than one beam of light (5); and
more than one electrically adjustable optical element (300) arranged to adjust the more than one beam of light (5) from the more than one light source (2) into more than one adjusted beam of light (25) with scattering patterns that are electrically variable.

13. The light module (1) according to claim 1, wherein the module (1) further comprises one or more switches or one or more sensors (350), or one or more switches as well as one or more sensors (350),
wherein the one or more switches (350) provide one or more functions selected from the group comprising:
i) switching one or more sources (2) on and off;
ii) switching all sources (2) on and off at the same time;
iii) electrically adjusting one or more electrically adjustable optical elements (300);
iv) adjusting the scattering properties of one or more beams of light (25);
v) adjusting the luminous intensity of one or more beams of light (25); and
wherein the one or more sensors (350) provide one or more functions selected from the group comprising:
i) detecting one or more of the states: opening, closing, locking, and unlocking of one or more doors;
ii) detecting a remote signal for one or more of the states: opening, closing, locking, and unlocking of one or more doors;
iii) detecting the presence of a driver and/or one or more passengers;
iv) detecting movement;
v) detecting a remote control signal intended to control one or more of the functions as described for the switches (350).

14. The light module (1) according to claim 12, wherein at least one of the adjustable optical elements (300) comprises a liquid crystal cell containing a liquid crystal material selected from the group comprising: an LC gel with negative dielectric anisotropy, a chiral LC gel, and a PDLC (polymer dispersed liquid crystal) material.

15. The light module (1) according to claim 12, wherein at least one of the adjustable optical elements (300) is arranged to provide at least one adjusted beam of light (25) comprising a beam with isotropic scattering properties in response to a driving signal (376).

16. A controller (304) for use in a light module (1) according to claim 1, the controller (304) being arranged to control, in response to an adjusting control signal (371), at least one element of a group of elements comprising the adjustable optical element (300) and the light source (2) by means of at least one driving signal (375, 376).

17. A controller (304) for use in a light module (1) according to claim 12, the controller (304) being arranged to control, in response to an adjusting control signal (371), at least one element of a group of elements comprising one or more adjustable optical elements (300) and one or more light sources (2) by means of at least one driving signal (375, 376).

18. A computer program product to be run on a controller (304) according to claim 16, the computer program product comprising the function of controlling, in response to an adjusting control signal (371), at least one element of a group of elements comprising the adjustable optical element (300) and the light source (2) by means of at least one driving signal (375, 376).

19. A computer program product to be run on a controller (304) according to claim 17, the computer program product comprising the function of controlling, in response to an adjusting control signal (371), at least one element of a group of elements comprising one or more adjustable optical elements (300) and one or more light sources (2) by means of at least one driving signal (375, 376).

20. Use of a light module (1) according to claim 1 as a multiple purpose light, preferably as a multiple purpose interior car light.

21. Use according to claim 20, wherein the use of the light module is selected from the group consisting of reading light, vanity light, approaching light, and stepping light.
